(19) United States
(12) Patent Application Publication
(10) Pub. No.: US 2026/0128771 A1
(43) Pub. Date: May 7, 2026

(54) TRAINING PPDU DESIGN FOR MILLIMETER WAVE LINKS

(71) Applicant: NXP USA, Inc., AUSTIN, TX (US)

(72) Inventors: Xiayu Zheng, San Jose, CA (US); Rui Cao, Sunnyvale, CA (US); Liwen Chu, San Ramon, CA (US); Hongyuan Zhang, Fremont, CA (US)

(21) Appl. No.: 19/382,558

(22) Filed: Nov. 7, 2025

Related U.S. Application Data
(60) Provisional application No. 63/717,603, filed on Nov. 7, 2024.

(51) Int. Cl. H04B 7/06; H04L 27/26

(52) U.S. Cl. CPC H04B 7/0617; H04B 7/06952; H04L 27/2613

(57) ABSTRACT

Methods and apparatus are described for beamforming training of a millimeter wave link (mmWave link) by a wireless multi-link device (MLD). The wireless MLD determine to perform a beam establishment procedure or a beam tracking procedure for the mmWave link and generates a mmWave link training PPDU (training PPDU). The training PPDU is a Null Data Packet (NDP) and includes a PHY preamble having at least a Short Training Field (STF), a Long Training Field (LTF), and a universal Signal field (U-SIG field) carrying beam training parameters. The wireless MLD transmits the training PPDU, via the mmWave link, for reception by a second wireless MLD. In an example, all or portions of the PHY preamble correspond to an upclocked PHY preamble of a sub-7 GHz orthogonal frequency-division multiplexing (OFDM) PPDU as defined by the IEEE 802.11 standard. The training PPDU may further include training field(s) and an Integrated Millimeter Wave SIG field.

### CROSS REFERENCE TO RELATED APPLICATIONS

The present U.S. Utility Patent application claims priority pursuant to 35 U.S.C. § 119(e) to U.S. Provisional Application No. 63/717,603, entitled “TRAINING PPDU DESIGN FOR MMWAVE LINK”, filed Nov. 7, 2024, which is hereby incorporated herein by reference in its entirety and made part of the present U.S. Utility Patent Application for all purposes.

### TECHNICAL FIELD

This disclosure relates generally wireless communications, and more specifically to beamforming training for a millimeter wave link.

### BACKGROUND

Wireless local area networks (WLANs) have evolved rapidly over the past couple of decades, including WLANs that conform to the Institute of Electrical and Electronics Engineers (IEEE) 802.11 family of standards. A typical 802.11-based WLAN may be formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

More recently, the 802.11be amendment to the IEEE 802.11 standard (“Wi-Fi 7”) has added support for Multi-Link Operation (MLO). This feature increases capacity by simultaneously sending and receiving data across different frequency bands and channels (e.g., 2.4 GHz, 5 GHZ, and 6 GHZ). With MLO, for example, an access point multi-link (AP MLD) simultaneously establishes multiple links with a non-AP MLD client over more than one frequency band in order to increase throughput, reduce latency, and improve reliability. The 802.11ad amendment to the IEEE 802.11 standard (“WiGig”) further defines a standalone high-rate mmWave PHY operating in the 57-71 GHz range.

### BRIEF DESCRIPTION OF THE DRAWINGS

FIG. 1 illustrates an example of a multi-link communications system in accordance with embodiments of the present disclosure;

FIG. 2 illustrates an example of a frame exchange sequence of a mm Wave beam tracking procedure initiated by a non-mm Wave link in accordance with an embodiment of the present disclosure;

FIG. 3 illustrates examples of legacy sub-7 GHz PPDU formats that may be redefined (in whole or part) as mmWave link training PPDUs in accordance with various embodiments of the present disclosure;

FIG. 4 illustrates an example of a training field sequence for training multiple mmWave beams using a single training PPDU in accordance with embodiments of the present disclosure;

FIG. 5 illustrates an example of a mmWave link Null Data Packet (NDP) in accordance with an embodiment of the present disclosure;

FIG. 6 is a table illustrating an example correspondence between a number of a transmit (Tx) radio frequency (RF) chains being trained and a number of LTF symbols carried in a TRN field(s);

FIG. 7 illustrates an example of an Integrated Millimeter Wave (IMMW) NDP in accordance with an embodiment of the present disclosure;

FIG. 8 illustrates another example of a mm Wave NDP including a data field in accordance with an embodiment of the present disclosure;

FIG. 9 illustrates an example of a training PPDU configured for beam tracking in accordance with an embodiment of the disclosure;

FIG. 10 is a flow chart illustrating an example method for performing a mm Wave link beamforming training procedure (e.g., a beam establishment or beam tracking procedure) in accordance with embodiments of the present disclosure; and

FIG. 11 illustrates an example of wireless multi-link device according to an embodiment of the present disclosure.

### DETAILED DESCRIPTION

The various implementations described in the following description relate generally to “training” physical layer (PHY) protocol data units (PPDUs) to support beamforming training operations for millimeter wave (mmWave) communications. The Institute of Electrical and Electronics Engineers (IEEE) has formed an 802.11 task force to develop an integrated mm Wave (IMMW) amendment (“802.11bq”) to the 802.11 standard. The amendment is intended to meet the demands (e.g., throughput, latency, accuracy, etc.) of emergent applications such as augmented/virtual reality and proximity ranging and sensing. For example, reductions in complexity and integration cost savings may be achieved by leveraging the multi-link operation (MLO) operations defined in the sub-7 GHz band (non-mmWave link) sections of the 802.11 standard to support non-standalone operations in mm Wave links.

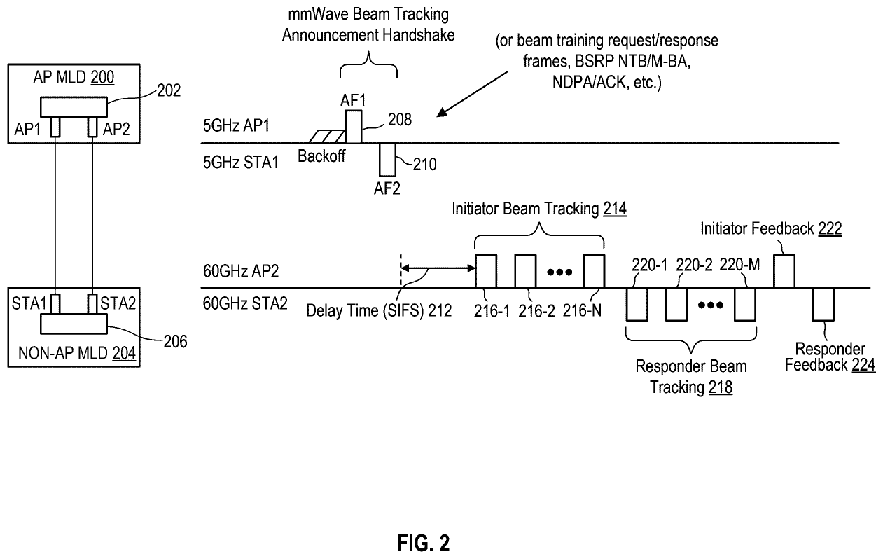

As described with reference to FIG. 2, MLO can be utilized to support beamforming procedures such as beam establishment and beam tracking procedures. For example, MLO can be utilized to assist an initiation packet exchange, training PPDU sequence and feedback frame transmission(s). The present disclosure describes various embodiments in which all or portions of existing sub-7 GHz PPDU formats (e.g., orthogonal frequency-division multiplexing (OFDM) PPDUs) as defined by the IEEE 802.11 standard are leveraged and, in some cases, redefined to carry training (TRN) field related parameters.

In an example method for beamforming training of a millimeter wave link (mm Wave link) according to the present disclosure, a first wireless multi-link device (MLD) determines to perform a beam establishment procedure or a beam tracking procedure for the mmWave link and generates a mmWave link training PPDU (training PPDU). In an example, the training PPDU is a Null Data Packet (NDP) and includes a PHY preamble and at least one training field (TRN field). The PHY preamble includes at least a Short Training Field (STF), a Long Training Field (LTF), and a universal Signal field (U-SIG field) carrying TRN field parameters and other beam/AWV related parameters. The wireless MLD transmits the training PPDU, via the mm Wave link, for reception by a second wireless MLD. In an example, all (or portions) of the PHY preamble correspond to an (upclocked) PHY preamble of a sub-7 GHz orthogonal frequency-division multiplexing (OFDM) PPDU as defined by the IEEE 802.11 standard.

As used herein, the term “non-legacy” may refer to PPDU formats and communication protocols conforming with the IEEE 802.11bq amendment to the IEEE 802.11 standard (also referred to as “integrated mmWave” or “IMMW”) and the IEEE 802.11bn amendment to the IEEE 802.11 standard (also referred to as Ultra High Reliability or “UHR” or “Wi-Fi 8”), as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bq (and 802.11bn) or future generations of the IEEE 802.11 standard. In some implementations, an 802.11bq training PPDU in accordance with the present disclosure may be configurable to leverage MAC/PHY frame formats from one or more versions of the IEEE 802.11 standard (e.g., through upclocking) while keeping the legacy frame structures and semantics largely intact.

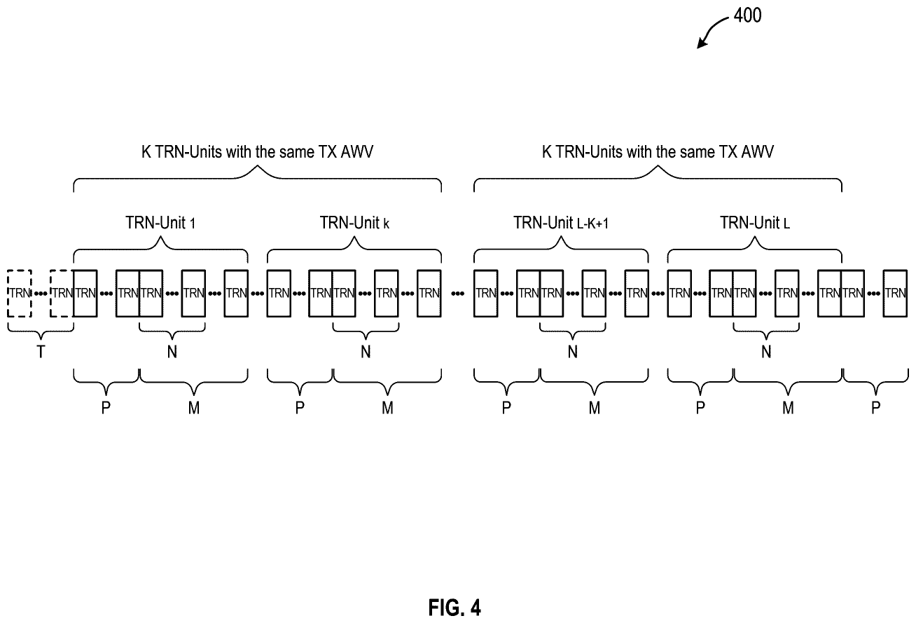

As may be used herein, the term “TRN field related parameters” refers generally to parameters that relate to training (TRN) fields/sequences (e.g., as may be used in a beam tracking procedure). Examples of TRN field parameters are described with reference to FIG. 4. As may also be used herein, the terms “AWV related parameters” and “beam/AWV related parameters” refer to parameters such as Tx beam index information and/or sector ID information, a transmit radio frequency (Tx RF) chain identifier, a training PPDU/countdown index, etc. For a beam establishment procedure, the beam index is the same as the training PPDU index if each training PPDU only trains one Tx or Rx beam. For a beam tracking procedure, a beam index may be derived from a training PPDU index and TRN field parameters. As used herein, the term “beam training parameters” may refer to various combinations or portions of TRN field related parameters and beam/AWV related parameters.

As may be used herein, the terms “antenna weight vector” (“AWV”) and “beam” are used interchangeably and refer to a vector of weights describing the excitation (amplitude and phase) for each element of an antenna array.

As may be used herein, the term “sector” refers to a transmit or receive antenna pattern corresponding to a sector identifier (ID). One or multiple AWVs can be used to cover a sector.

As may be used herein, the term “antenna array” refers to an array of antennas of a transmitter or receiver. An antenna array may be configured to cover overlapping or non-overlapping sectors. As may be used herein, an “RF chain” may connect to one or multiple antenna arrays in a particular implementation. For purposes of the following disclosure, only one antenna array is connected to an RF chain at a time, multiple RF chains can be used to transmit one or multiple data streams, and one RF chain may be considered equivalent to an antenna array.

As may be used herein, the terms “Tx RF chain” and “Tx antenna mask” generally refer to the Tx RF chain that is enabled.

As may be used herein, the term “beam index” may refer to one AWV of an RF chain or a Tx/Rx AWV pair for the corresponding RF chains.

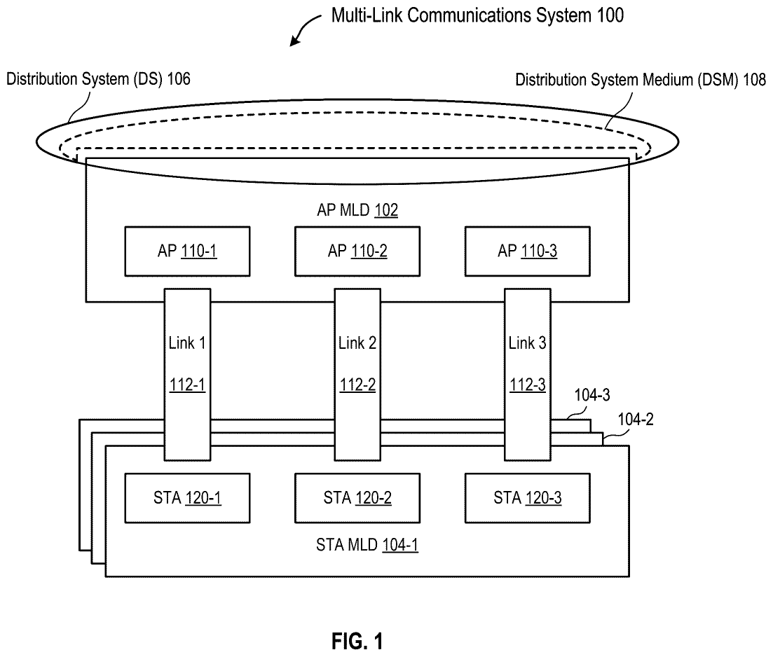

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices, which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as multiple AP MLDs and multiple STA MLDs, or a single AP MLD and a single STA MLD. In another example, the multi-link communications system includes more than three STA MLDs and/or less than three STA MLDs. Although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities that are common to multiple links (e.g., association establishment, reordering of frames, etc.) and a link specific part of the AP MLD 102, i.e., the APs 110-1, 110-2, and 110-3, implement the upper layer functionalities specific to a link and lower layer MAC functionalities (e.g., beaconing, backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 104 may operate in different frequency bands. For example, at least one of the APs 110-1, 110-2, or 110-3 of the AP MLD 104 operates in an Extremely High Frequency (EHF) band or the “millimeter wave (mm Wave)” frequency band. In some embodiments, the mm Wave frequency band is a band of radio wave frequencies between 30 Gigahertz (GHz) and 300 GHz. For example, a mmWave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 2.4/5 GHz band (e.g., with a 20/40/80/160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band or different frequency bands. For example, at least one of the STAs 120-1, 120-2, or 120-3 of the STA MLD 104-1 operates in the mm Wave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 2.4/5 GHz band (e.g., with a 20/40/80/160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the wireless communications links in the multi-link communications system include one or more 2.4 GHz, 5 GHz, 6 GHZ, 45 GHz and/or 60 GHz links.

In the embodiment depicted in FIG. 1, the communications links 112-1, 112-2, and 112-3 between the AP MLD and the STA MLD 104-1 involve at least one mm Wave link. For example, the communications links 112-1, 112-2, and 112-3 between the AP MLD 102 and the STA MLD 104-1 include a mmWave link (e.g., a 45/60 GHz link) between an AP of the AP MLD 102 and an STA of the STA MLD 104-1 operating in a mmWave frequency band (e.g., a 45/60 GHz frequency band) and two non-mmWave links (e.g., 2.4 GHz, 5 GHZ, or 6 GHz links) and two mmWave links (e.g., a 45 GHz link and a 60 GHz link) between APs of the AP MLD 102 and STAs of the STA MLD 104-1 operating in non-mm Wave frequency bands (e.g., 2.4 GHz, 5 GHZ, or 6 GHz frequency bands). In another example, the communications links 112-1, 112-2, and 112-3 between the AP MLD 102 and the STA MLD 104-1 include two mmWave links (e.g., 45/60 GHz links) between APs of the AP MLD 102 and STAs of the STA MLD 104-1 operating in mm Wave frequency bands (e.g., 45/60 GHz frequency bands) and one non-mmWave link (e.g., a 2.4 GHZ, 5 GHZ, or 6 GHz link) between an AP of the AP MLD 102 and an STA of the STA MLD 104-1 operating in a non-mmWave frequency bands (e.g., a 2.4 GHz, 5 GHZ, or 6 GHz frequency band). The control and management of a mmWave link, for example a 45 GHz/60 GHz link, may be performed in a non-mm Wave link (e.g., a 2.4 GHZ, 5 GHZ, or 6 GHz link). For example, the association of a non-AP MLD with a mm Wave link can be done through a non-mm Wave link.

Unlicensed mmWave bands such as ˜60 GHz (57-71 GHz band in the United States and European Union) and ˜45 GHz (China) have been studied for multi-gigabit communication, including various standardization efforts in the IEEE (e.g., the 802.11ad (or “WiGig”) and 802.11ay amendments to the 802.11 standard). Beamforming with a large number of antennas is considered an important mechanism to compensate for the relatively high pathloss/attenuation in mmWave bands. To balance cost and performance, beamforming may be composed of analog beamforming and/or digital beamforming (or hybrid beamforming in the case of MIMO) for Directional Multi-Gigabit (DMG) beamforming.

At a high level, DMG beamforming includes a sector level sweep (SLS) phase determine antenna weight vectors (AWV) for analog beamforming to enable the AP and STA to communicate. The AP is the SLS initiator and the SLS procedure may conducted periodically based on the beacon interval. A beam refinement protocol (BRP) phase may further train the receive and transmit antenna array(s) of a device to improve the device's transmit (Tx) and receive (Rx) antenna configuration. The BRP phase include an iterative procedure utilizing a specially defined BRP frame. When multiple Tx/Rx RF chains (each connecting to an antenna array) are enabled, digital beamforming training can be further conducted following completion of the BRP procedure and applying the analog AWVs on both the Tx/Rx RF chains. Under the DMG standalone mode, beamforming training packet exchanges are conducted in the mmWave band and a special control PHY with a 15 dB sensitivity margin over the lowest MCS is defined to assist the training procedure. This relatively complex beamforming protocol design may increase the cost of DMG-compliant devices and potentially limit widespread market adoption.

Under MLO, the control/management information for a mmWave link beam establishment procedure (which may alternatively be referred to as a sector level sweep (SLS) procedure) to select a transmit (Tx) and receive (Rx) beam pair (or “Tx-Rx beam pair”) can be exchanged in a different ways. In an example, a control frame and ACK frame exchange (e.g., using one or more null data packet announcements (NDPAs) if the training PPDU is in NDP format, which may also be more generally referred to herein as an “announcement frame” without assumption of training PPDU format) is performed over a non-mmWave link to initiate and negotiate the beam establishment procedure. In this example, sector sweep PPDU measurements are performed over the mmWave link, and beam establishment feedback information may be exchanged over the non-mmWave link. Determining whether a non-mmWave link or a mmWave link is utilized may depend, for example, on the existence of a known Tx/Rx beam pair providing sufficient beamforming gain such that the beam training feedback and corresponding ACK frame(s) can be received on both sides of the mmWave link. Beam tracking procedures may also be utilized to improve the results of an initial beam establishment procedure or sector sweep. Examples of frame exchange sequences for a beam tracking procedure are described in greater detail with reference to FIG. 2.

In an example, an established mmWave link between MLDs may suffer from beam failure (or possible beam failure) when there is a sudden deterioration in channel conditions. Channel deterioration can be caused, for example, by movement of one of the MLDs, obstacles that affect signal quality (e.g., physical objects in a line-of-site between the transceivers of the MLDs that may reflect or absorb wireless signals), other wireless signals in a shared wireless channel or in adjacent channels, etc. Such interference can vary over time and be difficult to predict. When a mmWave link deteriorates, mm Wave link beamforming training procedures (e.g., beam establishment and/or beam tracking procedures) such as described in the following embodiments can be employed to restore or improve the robustness of the link. A mmWave link beamforming training procedure(s) may be initiated, for example, by a data packet recipient upon detecting a deteriorated mm Wave link that has not completely failed.

FIG. 2 illustrates an example of a frame exchange sequence of a mm Wave beam tracking procedure initiated by a non-mmWave link in accordance with an embodiment of the present disclosure. In the illustrated example, frames are exchanged between an AP MLD 200, which includes a common MAC controller 202 and two wireless APs AP1 and AP2, and a non-AP MLD 204, which includes a common MAC controller 206 and two wireless STAs STA1 and STA2. In some embodiments, the common MAC controller 202 implements upper layer MAC functionalities (e.g., association establishment, reordering of frames, etc.) of the AP MLD 200 and a link specific part of the AP MLD 200, e.g., AP1 and AP2, implements lower layer MAC functionalities (e.g., beaconing, backoff, frame transmission, frame reception, etc.) of the AP MLD 200. In some embodiments, the common MAC controller 206 implements upper layer MAC functionalities (e.g., association establishment, reordering of frames, etc.) of the non-AP MLD 204 and a link specific part of the non-AP MLD 204, e.g., STA1 and STA2, implements lower layer MAC functionalities (e.g., backoff, frame transmission, frame reception, etc.) of the non-AP MLD 204. The AP MLD 200 depicted in FIG. 2 can be an embodiment of the AP MLD 102 depicted in FIG. 1. In addition, the non-AP MLD 204 depicted in FIG. 2 is an embodiment of the STA MLDs 104-1, 104-2, and 104-3 depicted in FIG. 1.

In the example depicted in FIG. 2, a mmWave link (e.g., a 45 GHz link or a 60 GHz link) is established between AP2 and STA2, which both operate in a mmWave frequency band (e.g., a 45 GHz or 60 GHz frequency band) and are capable of mm Wave communications, and a non-mmWave link (e.g., a 2.4/5/6 GHz band link) is established between AP1 and STA1, which both operate in a non-mm Wave (or sub-7 GHz) frequency band (e.g., a 2.4 GHz, 5 GHZ, or 6 GHz frequency band) and are capable of non-mm Wave communications. Although the AP MLD 200 is shown in FIG. 2 as including two APs, other embodiments of the AP MLD 200 may include more than two APs. In addition, although the non-AP MLD 204 is shown in FIG. 2 as including two non-AP STAs, other embodiments of the non-AP MLD 204 may include more than two non-AP STAs.

The illustrated frame exchange sequence of an example of mmWave beam tracking procedure, which is generally used to optimize antenna settings for an existing mmWave link used to transmit data between a first wireless device and a second wireless device. For example, the first wireless device can transmit training fields to the second wireless device, where the first wireless device can apply a different transmission beamforming pattern when transmitting each training packet. The second device generally determines which of the training fields had the highest quality (e.g., having the highest signal-to-noise ratio (SNR) and/or the lowest bit error rate (BER) and notifies the first wireless device, which can then utilize the transmission beamforming pattern that yielded the highest quality packet. The second device may also sweep through different receive beamforming patterns via the Rx training fields of a training PPDU that it detects. Similarly, to determine a transmission beamforming pattern to be applied by the second device and a reception beamforming pattern to be applied by the first wireless device when receiving data from the second wireless device, the second wireless device transmits training fields to the first wireless device, and the first wireless device applies a different beamforming pattern when receiving each training PPDU. The first wireless device may determine which of the training fields has the highest quality, notify the second device of the corresponding transmission beamforming pattern, and utilize the corresponding reception beamforming pattern that yields the highest quality packet.

Referring more specifically to FIG. 2, a frame exchange is illustrated for a beam tracking procedure (which may also be referred to herein as a beam refinement procedure or protocol). In an example, the beam tracking procedure may be initiated by the AP MLD 200 or the non-AP MLD 204 (e.g., in response to detecting a deterioration in channel conditions or on a periodic/scheduled basis).

The beam training parameters for the illustrated beam tracking procedure may be negotiated through a mmWave beam tracking announcement handshake that includes an announcement frame (AF) AF1 208 transmitted by AP1, followed by an AF2 210 transmitted by STA1. In an example, a number of Tx beams may be indicated by the AP1 in the AF 208. In another example, a number of Rx beams may be indicated by the STA1 in AF 210 if Rx beam training for each AP2 transmit beam is needed (otherwise, the corresponding best beams can be used). In another example, the number of Tx beams and the number of Rx beams for beam training may be advertised in respective mmWave link capabilities elements exchanged by the AP MLD 200 and non-AP MLD 204 (e.g., when the number of Tx or Rx beams is fixed). In another example, the PPDU format of a training PPDU may include TRN field related parameters and/or other beam/AWV related parameters, such as Tx beam index information and/or sector ID information, a Tx RF chain identifier, a training PPDU/countdown index, etc. Such parameters may differ depending on whether a beam establishment or beam tracking procedure is performed. For example, relevant parameters for beam establishment may include beam index/sector ID information. For beam tracking, TRN field related parameters (such as described with reference to FIG. 4) may be used to derive the Tx beam index.

In another example (not separately illustrated), beam training parameters may be negotiated through a non-mmWave announcement handshake (e.g., when a beam establishment procedure is performed instead of a beam tracking procedure, and the best available Tx/Rx beam information from a previous beam establishment/tracking procedure is not available at the AP and STA). In this example, the non-mm Wave link announcement frame handshake can include Tx/Rx beam information, such that a training PPDU can apply the Tx beam in the preamble (non-TRN fields), and the receiver can apply the corresponding Rx beam for packet detection. In a further example, the (best available) Tx/Rx beam information can be exchanged through other management/frame(s) via a non-mm Wave link, and the announcement frame handshake occurs over the mmWave link using the Tx/Rx beam information.

In another example, an updated null data packet announcement (NDPA) may be used to negotiate mmWave beam establishment and beam tracking procedures, and may indicate whether the beam establishment/tracking is performed through cross-link or not. In some embodiments, a special STA information field is defined to indicate whether the cross-link beam establishment is requested or not, and the link ID of the mmWave link in the cross-link beam establishment is requested. The link ID may be required when a MLD includes more than one mm Wave link. A sector number being trained can also be announced in the NDPA or in a mmWave link's capabilities element.

In the illustrated example, the AP MLD 200 may request a sequential reverse link beam tracking procedure (e.g., due to no Tx/Rx beam reciprocity and/or the reverse direction also has degradation) wherein both Tx beams and Rx beams are tracked. In this example, a beam tracking announcement handshake and feedback exchange may be conducted over the mm Wave link when a Tx/Rx beam pair to connect the link is available (e.g., from a previous beam establishment or beam tracking procedure) and the request/response frame (and the feedback or ACK uses the same type of PPDU) can be received with this information.

In the example illustrated in FIG. 2, the beam tracking procedure may include Tx beam training for STA2 and/or Rx beam training for AP2 (which may also be referred to as “reverse direction beam tracking” or “reverse link beam tracking”) in which the STA2 transmits, over the mmWave link, one or more training PPDUs (e.g., including training (TRN) fields 220) to the AP2. In another example, the reverse direction beam tracking may not be conducted sequentially. Rather, the reverse direction beam tracking can be conducted via another announcement frame handshake initiated by STA 2 (e.g., to exchange beam information for the desired direction). In an example in which Rx beam training is not considered, the initial Rx beam for each Tx beam may be a Rx beam corresponding to the best available Tx beam as used in a previous beam establishment procedure or other beam training procedure. In another example, the non-AP MLD 204 may select a Rx beam for use in the responder beam tracking 218. In yet another example, the number of Tx beams may be a subset of available Tx beams that is determined based on an earlier beam establishment procedure or beam tracking procedure conducted by the AP MLD 200 and non-AP MLD 204.

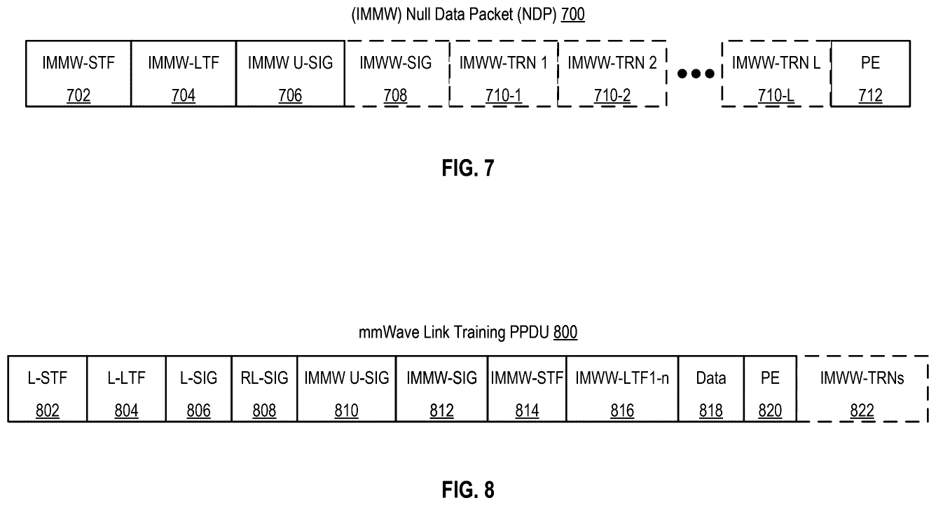

In the illustrated example, after the delay time 212 (e.g., SIFS or other predefined IFS, negotiated time, etc.), an initiator beam tracking procedure 214 is performed over the mmWave link between AP2 and STA2 using a number of training PPDUs (or sequences) 216-1, . . . , 216-N, where N is a positive integer, that are transmitted via the mm Wave link (e.g., a 60 GHz band link) between AP2 and STA2 and are separated by a specific IFS. Subsequently, a responder beam tracking procedure 218 is performed over the mm Wave link using a number of training PPDUs 220-1, . . . , 220-M, where M is a positive integer, which are transmitted from STA2 to AP2 through the mm Wave link and are separated by a specific IFS. In an example, each training PPDU 216/220 may include multiple TRN fields (such as illustrated in FIGS. 7-9), and each TRN field can be used to train a Tx or Rx beam.

In this example, the AP2 of AP MLD 200 transmits beam training feedback information (“Initiator feedback”) 222 over the mm Wave link. In the illustrated example, the STA2 of non-AP MLD 204 transmits beam training feedback information (“Responder feedback”) 224 to AP2 via the mmWave link. In an example, the non-AP MLD 204 can identify one or more training fields having a highest received signal strength (or RSSI level), which generally corresponds to the best candidate Tx or Rx beam.

The beam tracking procedure of FIG. 2 is provided by way of example to illustrate the general process, and other types of frame exchanges may be utilized. For example, the beam tracking announcement handshake may utilize various other frames, such as beam training request/response frames, Buffer Status Report Poll (BSRP) non-Trigger based (NTB)/multi-STA Block Acknowledge (M-BA) frames, NDPA/ACK, etc. In other examples, all or part of the beam tracking announcement handshake (or a beam establishment procedure) may occur over a mmWave link.

In various embodiments described herein, the training PPDU format for beam establishment and beam tracking leverages or reuses the upclocking of one or more (existing) sub-7 Ghz OFDM PPDU format(s) as defined by the IEEE 802.11 standard. In an example, various fields/subfields of a sub-7 GHz OFDM PPDU frame format are utilized and redefined for mmWave beamforming training.

In some embodiments, the mmWave link training PPDU design leverages or reuses a sub-7 Ghz NDP frame format with modifications and/or expansions. In an example, the training PPDU includes additional TRN fields at the end of the training PPDU to facilitate the training efficiency, especially for beam tracking and, in some scenarios, beam establishment. In this example, TRN field related parameters, including analog beam training AWV parameters, are defined in a PHY preamble (or “preamble”) (with field/subfield redefinition).

In other embodiments, the mmWave link training PPDU design leverages or reuses a sub-7 Ghz control or management frame format having a data portion that is used to carry TRN field related parameters (e.g., when an NDP preamble is unable to carry all the required parameters, or for other efficiency considerations such as reusing the beam establishment data frame for beam tracking). In an example, the training PPDU for both beam establishment and beam tracking can have a same non-TRN preamble format (including BW but not necessarily the contents in SIG fields) design such that the best AWV found in beam establishment can be used for beam tracking packet detection. In another example, the TRN field(s) reuse the Long Training Field (LTF) sequence design of the sub-7 GHz PPDU.

In various embodiments of beam establishment and beam tracking procedures described herein for a mmWave link, an antenna weight vector (AWV) or beam is trained that is the same for all of the subcarriers of each antenna. As a result, the bandwidth of the training PPDU can be different from the bandwidth of a data PPDU (e.g., depending on whether the trained antenna weight vector for given bandwidth is sufficiently close to an optimal antenna weight vector).

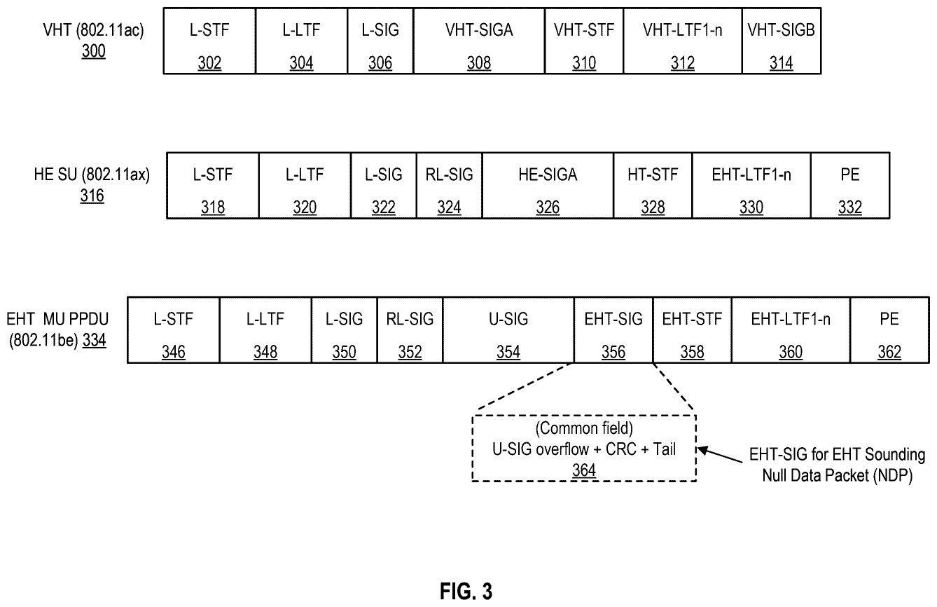

FIG. 3 illustrates examples of legacy sub-7 GHz PPDU formats that may be redefined (in whole or part) as mmWave link training PPDUs in accordance with various embodiments of the present disclosure. The illustrated examples include a VHT PPDU 300, an HE SU PPDU 316, and an EHT MU PPDU 334. As presently defined in the 802.11 standard for sub-7 GHz operation (i.e., VHT/HE/EHT), a Null Data PPDU (NDP) format is utilized as the training PPDU for digital transmit beamforming, where the NDP is usually a variant of single user (SU) PPDU (except for EHT which utilizes a multi-user (MU) PPDU for both SU and MU without the data portion). In these examples, the bandwidth (BW) of the NDP is generally the same as that of a data PPDU of a corresponding frame exchange(s), as digital beamforming procedures may need the steering matrix for every subcarrier to be estimated and then applied at the transmitter.

Referring to the illustrated examples, the (PHY) preamble of the VHT PPDU 300 includes a legacy short training field (L-STF) 302, a legacy long training field (L-LTF) 304, a legacy signal (L-SIG) field 306, a VHT-SIGA field 308, a VHT-STF 310, one or more VHT-LTFs 312, and a VHT-SIGB field 314. The HE SU PPDU 316 includes a L-STF 318, a L-LTF 320, a L-SIG field 322, a repeated L-SIG (RL-SIG) field 324, an HE-SIGA field 326, an HT-STF 328, one or more EHT-LTFs 330, and a packet extension (PE) field 332. The EHT MU PPDU 334 includes a L-STF 346, a L-LTF 348, a L-SIG field 350, a RL-SIG field 352, a U-SIG field 354, an EHT-SIG field 356, an EHT-STF 358, one or more EHT-LTFs 360, and a packet extension (PE) field 362. In the illustrated example, the EHT-SIG field 356 includes a Common field 364 carrying U-SIG overflow information, a Cyclic Redundancy Check (CRC) field and tail bits.

In general, the L-STF is used by a recipient device to detect the start of the PPDU or portion thereof and to establish orthogonal frequency division multiplexed/access (OFDM/A) symbol timing for data detection, i.e. frame acquisition and time synchronization. The L-LTF is used for channel estimation/training information detection. Channel estimation is a process of determining channel characteristics (e.g., a frequency response) of a channel in which the PPDU is transmitted. The L-SIG field includes information for data decoding and coexistence such as a 12 bit packet length value (LENGTH), rate information, etc.

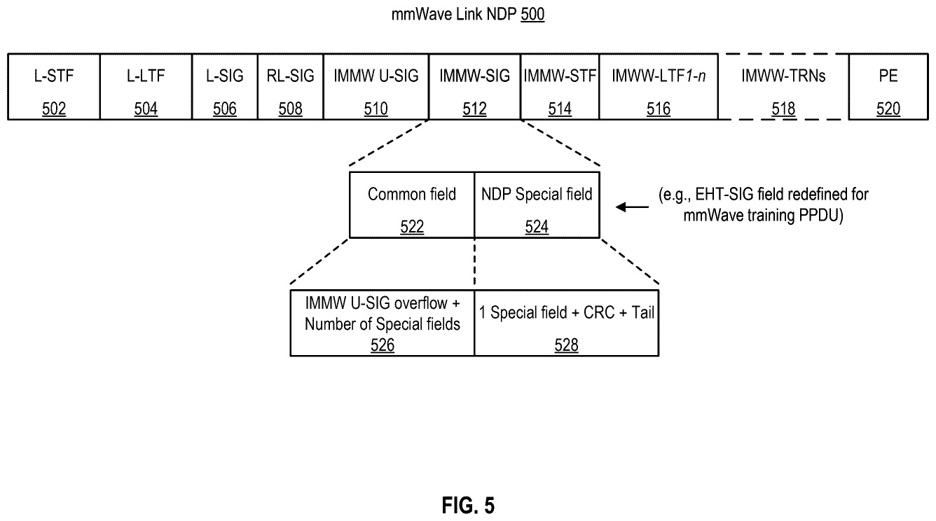

In various embodiments, a (VHT/HE/EHT) sub-7 GHz NDP PPDU format such as shown in FIG. 3 is fully reused for generating a training PPDU, but with the SIG-A/U-SIG/SIG-B fields redefined. In examples, the User specific fields of an HE-SIGA field 326, U-SIG field 354, or EHT-SIG field 356 are redefined to include TRN field related parameters. An example of an EHT MU PPDU 334 format leveraged as a mm Wave link Null Data Packet (NDP) is described with reference to FIG. 5.

FIG. 4 illustrates an example of a training (TRN) field sequence 400 for training multiple mmWave beams using a single training PPDU in accordance with embodiments of the present disclosure. In the illustrated example, the TRN field related parameters may include one or more of the following parameters to enable different types of training configurations:
TRN length (L): the number of TRN-Units
K: the number of TRN-Units for which the transmitter maintains the same transmit AWV
T: the transition interval between the processing of previous data and the TRN fields (may be replaced with PE)
P: the number of TRN fields which transmit the same AWV as the preamble (may not be needed for OFDM)
M: the transmitter may change the Tx AWV at the beginning of each set of N TRN subfields for beam training
N: the consecutive TRN subfields within the M TRN subfields that are transmitted with the same AWV.

A training PPDU may have different types, such as a Tx training only type, an Rx training only type, or a Rx/Tx training type (for purposes of beam establishment, Rx training only TRN fields may be utilized in certain scenarios). The inclusion of multiple TRN fields allows one training PPDU to test many AWVs in rapid succession, minimizing overhead and airtime as compared to separate training PPDUs.

In an example, a TRN field includes a known, prearranged waveform (e.g., corresponding to a legacy LTF field or other training symbols) so that a receiver can perform synchronization, channel estimation, gain control, and beam evaluation before or during data transmission. When repeated under different antenna weight vectors (AWVs), the TRN field(s) provide per-beam metrics so the best beam or steering weights can be selected.

In an example of beam establishment, the TRN fields may be transmitted by sweeping AWVs such that the receiving device records per-beam metrics. The receiving device may use such metrics to further (and efficiently) close the beamforming gap in mmWave link between the beam establishment and beam tracking procedures.

With respect to a training PPDU generated for beam establishment, if a beam establishment procedure only utilizes relatively coarse beams, the best detected beam may still have a several dB gain gap as compared to the best Tx/Rx beam pair found by beam tracking procedure trains fine beams for both Tx and Rx. Accordingly, the best beam detected by the beam establishment procedure may limit the range of a mm Wave link if the training PPDU used for beam establishment has the same associated sensitivity as that of the training PPDU used for beam tracking.

One example to compensate for the beamforming gap includes use of a smaller bandwidth (BW) for the beam establishment training PPDU, combined with an extended range (ER)-dual carrier modulation (DCM) or similar scheme in order to achieve additional power gain as compared to a data PPDU for packet detection/preamble decoding, thereby avoiding link range limitations. In an example, DCM is only utilized when a data portion is included in the training PPDU. In another example, the extended range (ER) preamble power boost is utilized to improve preamble detection/decoding by ˜3 dB as compared to a training PPDU transmitted without the power boost. The improvements in detection/decoding may be somewhat limited for short duration training PPDUs as the total transmit power will be increased to boost the power for the PHY preamble, however, and use of a smaller bandwidth may be more meaningful if range is an important consideration. In another example, the beam establishment training PPDU is configured for one-stream transmission and only one Tx AWV/beam is applied across the whole beam establishment training PPDU, and one Tx RF chain is enabled for each beam establishment training PPDU.

With respect to a training PPDU generated for beam tracking, the non-TRN fields may have the same bandwidth and preamble design as the beam establishment training PPDU for purposes of packet detection and be applied using the best available Tx AWV/beam obtained from a beam establishment procedure or previous beam tracking procedure (e.g., using a chosen transmitter). In an example, one or more TRN fields can be transmitting with a differing beam applied than a beam used to transmit non-TRN fields, and the beam index to TRN subfield mapping is maintained at the transmitter or receiver depending on the type of beam training (Tx or Rx).

In another example, a TRN field may have the same BW as that of a (mmWave) data packet to improve measurement accuracy. In a further example, bandwidth information for a TRN field is defined in a PHY preamble of the training PPDU. In another example, when multiple transmit RF chains are enabled simultaneously, each TRN field can be constructed by applying a spatial expansion and mapping a single space-time stream to all transmit RF chains using orthogonal waveforms.

FIG. 5 illustrates an example of a mmWave link Null Data Packet (NDP) 500 in accordance with an embodiment of the present disclosure. In this example, the format of the mm Wave link NDP 500 is leveraged from the EHT MU PPDU 334 format shown in FIG. 3. The mm Wave link NDP 500 includes a L-STF 502, a L-LTF 504, a L-SIG field 506, a RL-SIG field 508, an Integrated Millimeter Wave (IMMW) U-SIG field 510, an IMMW-SIG field 512, an IMMW-STF 514, one or more IMMW-LTFs 516, one or more IMMW TRN fields 518, and a packet extension (PE) field 520. The PE field 520 is included to allow for sufficient processing time (e.g., beam ranking processing time) when immediate feedback is required in the same mmWave link, etc.

In an example, the U-SIG field and overflow bits in the EHT-SIG frame of an EHT MU PPDU can be redefined as indicated by redefined bits of the PHY version identifier subfield (U-SIG1[B0-B2]) and PPDU type and compression mode subfield (U-SIG2[B0-B1]) to include TRN field and AWV related parameters in the IMMW U-SIG field 510 and IMMW-SIG field 512. Continuing with this example, the PHY version identifier subfield may include a different value from EHT (e.g., the same as UHR) to identify a mm Wave link PPDU. In addition, the PPDU type and compression mode subfield may include a differing values to indicate either a IMMW SU or a Training (Sounding) PPDU in a mmWave link.

In the illustrated example, the IMMW-SIG field 512 includes a Common field 522 carrying IMMW-SIG overflow information and a number of Special fields (526). the IMMW-SIG field 512 further includes an NDP Special field 524 carrying a Special field, a CRC field and tail bits (528). In this example, a User special field is leveraged (note that the EHT NDP does not include a User specific field) and repurposed as a mmWave NDP Special field to carry (remaining) TRN field and AWV related parameters. In an example, one or multiple mmWave NDP Special fields are included depending on the number of bits which need to be carried. In another example, each Special field has 22 bits (corresponding to a User special field).

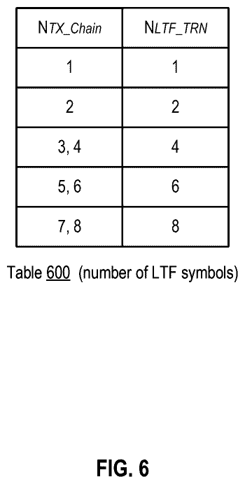

FIG. 6 is a table 600 illustrating an example correspondence between a number of a transmit (Tx) radio frequency (RF) chains being trained and a number of LTF symbols carried in a TRN field(s). In an example of a TRN field sequence design, each TRN subfield is composed of the same long training field (LTF) sequence as used in the IMMW LTF field, which could reuse the LTF sequence design of a VHT/HE/EHT PPDU depending on which frame format is utilized for upclocking. Alternatively, a new sequence design could be utilized.

In an example, if multiple transmit RF chains are trained altogether, orthogonal waveform is applied on each transmit chain with an orthogonal matrix, e.g., the P matrix as for sub-7 GHz can be reused. In the illustrated example, the number of LTF symbols N_{LTF_TRN} in each TRN subfield has the illustrated relationship with the number of transmit chains N_{TX_Chain}, e.g., 1:1, 2:2, 3/4:4, 5/6:6 or 7/8:8.

FIG. 7 illustrates an example of an Integrated Millimeter Wave (IMMW) NDP 700 in accordance with an embodiment of the present disclosure. In this example, the newly-defined format of the IMMW NDP includes a number of bits and fields that are defined to include all of the necessary AWV/TRN field related parameters in the PHY preamble (e.g., fields 702-710). The illustrated IMMW NDP 700 includes an IMMW-STF 702, a IMMW-LTF 704, an IMMW U-SIG field 706, an IMMW-SIG field 708, one or more IMMW-TRN fields 710-1-710-L, and a packet extension (PE) field 712. In this example, the IMMW-STF 702, IMMW-LTF 704, and IMMW U-SIG field 706 may be collectively referred to as a packet detection portion of the PHY preamble.

In a design example, if the IMMW U-SIG field 706 and IMMW-SIG field 708 are not able to carry all of the AWV/TRN field related parameters, a special NDP field(s) (e.g., which may include a redefined User specific field or another newly-defined field) may be included to carry the remaining AWV/TRN field related parameters. In another example, the IMMW-STF 702, IMMW-LTF 704, IMMW U-SIG field 706, and/or IMMW-SIG field 708 can be duplicated over smaller subchannels of the relevant operating bandwidth (e.g., when such fields are based on upclocking of a sub-7 GHz PPDU having duplicated L-STF/L-LTF fields). In certain beam establishment scenarios where TRN fields are not needed, the IMMW-SIG field 708 and IMMW-TRN fields 710-1-710-L may be omitted and all (or most of) the AWV related parameters can be defined in the IMMW U-SIG field 706. In another example in which a VHT/HE/EHT sub-7 GHz PPDU format is leveraged, a separate control frame exchange may be utilized to disseminate AWV related parameters, while TRN field related parameters are included in the PHY preamble.

FIG. 8 illustrates another example of a mmWave NDP 800 including a data field in accordance with an embodiment of the present disclosure. The illustrated mm Wave NDP 800 includes an L-STF 802, a L-LTF 804, L-SIG field 806, a RL-SIG field 808, an IMMW U-SIG field 810, an IMMW-SIG field 812, an IMMW-STF 814, one or more IMMW-LTFs 816, a data field 818, a PE field 820, and one or more appended IMMW-TRN fields 822.

In an example, the training PPDU 800 leverages a control or management frame and utilizes the corresponding data portion to carry beam training parameters (e.g., at least a portion of the AWV related parameters). Continuing with this example, portions of the preamble may be redefined as described above. For example, a U-SIG field or EHT-SIG field may be redefined to include TRN field related parameters. In another example, an IMMW-SIG field 812 may not need a User specific field (as distinguished from an EHT NDP), and AWV related parameters can be included in the data field 818 (e.g., with limited training related bits in the PHY preamble). If a VHT frame format is leveraged, the number of training related bits in the PHY preamble can be similarly limited.

In another example, the training PPDU 800 leverages a QoS data frame format and appends the IMMW-TRN fields at the end of packet (e.g., for a beam tracking procedure). In this example, AWV/TRN field related parameters can be included in the PHY preamble, as the data field 818 may need to carry QoS data. In another example, the L-SIG 802, L-LTF 804, L-SIG field 806, and RL-SIG 808 field can be replaced with similarly designed fields such as the IMMW-STF 702 and IMMW-LTF 704 of FIG. 7 if the mm Wave NDP 800 uses a newly defined format for packet detection, etc.

In an example of a beam establishment procedure conducted to establish or recover a mmWave link between an AP and STA, each training PPDU can be applied using a single AWV across the entire PPDU for packet detection to identify an acceptable Tx/Rx AWV/beam pair. In a further example, a special control PHY mode having higher sensitivity than the lowest MCS for a data PPDU may be defined for use in beam establishment. This approach may require additional design work (beyond upclocking from a sub-7 GHz OFDM mode), and non-OFDM may not be preferred. Using an MLO-assisted beam establishment procedure, the gap between the range achieved by beam establishment with directional receive and the optimal Tx/Rx AWV/beam pair identified by beam tracking can be further reduced. In this example, if the training PPDU for beam establishment has (a few dB) better sensitivity than a data PPDU transmitted with Tx/Rx AWV/beam pair without relying on a special control PHY design, the range in mmWave link should not be significantly affected. In the event that the performance of a mmWave link is not sufficient, data transfer can be switched from the mm Wave link to the non-mm Wave link.

As described above, because of the multiple bandwidths supported in sub-7 GHz PPDU formats, a smaller bandwidth can be used for a beam establishment training PPDU as compared to that of a data PPDU in order to achieve additional power gain or sensitivity improvement. In addition, an extended range (ER)-dual carrier modulation (DCM) scheme can be applied to the training PPDU format and combined with a smaller bandwidth training PPDU. A smaller bandwidth training PPDU may be useful as beam establishment can utilize a wide beam (with lower resolution), and the large coherent bandwidth in mmWave (for a mostly line of sight (LOS) channel) may mean that the power gain outweighs potential beam accuracy loss due to the smaller bandwidth.

The use of a smaller BW training PPDU for beam establishment can be implemented in different ways. In a first option, the training PPDU uses the same upclocked version of a sub-7 GHz PPDU format as the data PPDU, but with a smaller bandwidth (BW). Optionally, an ER/ELR or DCM type of enhancement can be applied with reasonable complexity. In this example, the bandwidth for the training PPDU can calculated as follows: BW_{training,sls}=max (BW_{min,ppdu}, BW_{operating,data}/max_N_{ratio,sls}), where BW_{min,ppdu} is the minimum PPDU BW in the mmWave link based on the same upclocking from sub-7 GHz as the mm Wave link data PPDU (e.g., 20 MHz to 160 MHz available BW in 5 GHZ). For example, if the mmWave link data PPDU has BW_{operating,data}=640 MHz, which is upclocked by 8× from a 5 GHz 80 MHz PPDU format, then BW_{min,ppdu}=20×8=160 MHz, where max_N_{ratio,sls} is the maximum required BW ratio between the device operating BW and potential beam establishment training PPDU and may compensate for the beamforming (BF) gain gap between beam establishment procedures and beam tracking procedures.

In an example, N_{ratio,sls}=BW_{operating,data}/BW_{training,sls} is defined as the total actual power gain over a mmWave data PPDU, and is approximately 10*log₁₀(N_{ratio,sls}) dB. In another example, if the mmWave link minimum PPDU BW is upclocked from a PPDU format in sub-7 GHz with duplicate 20 MHz preamble for packet detection, the training PPDU can be designed using the same upclocking from the sub-7 GHz PPDU format with 20 MHz preamble for packet detection. If N_{ratio,sls}<max_N_{ratio,sls}, the range may be limited by beam establishment training.

In a second option, when N_{ratio,sls}<max_N_{ratio,sls}, the BW of the beam establishment training PPDU can be effectively reduced through less upclocking from a sub-7 GHz by

$$\frac{{max\_N}_{r a tio , sls}}{{N}_{r a tio , sls}} ,$$

such that the BW of the training PPDU can be smaller than the minimum PPDU BW (BW_{min,ppdu}) of the mmWave link. In this manner, further power gain/sensitivity can be realized as compared to the beam establishment training PPDU described in the first option. Training PPDU detection using this option may be enabled by an announcement frame exchange in a non-mmWave link to initiate the start of beam establishment training and exchange required information. A receiver device may exit the reduced upclocking mode following the training procedure.

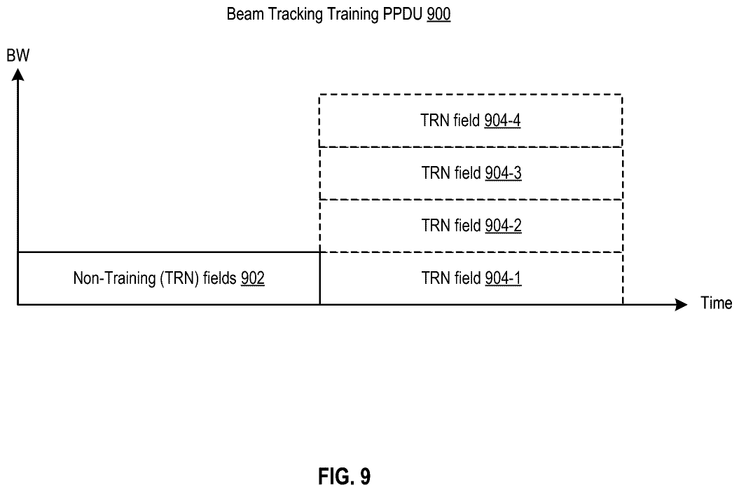

FIG. 9 illustrates an example of a training PPDU 900 configured for beam tracking in accordance with an embodiment of the disclosure. In operation, a beam tracking procedure is generally (but not necessarily) conducted shortly after a beam establishment procedure and may be initiated periodically or on demand from a receiving device for beam tracking/beam refinement. In an example, the non-TRN fields 902 of the beam tracking training PPDU 900 can have the same bandwidth and preamble format as a corresponding beam establishment training PPDU when the training PPDUs use the same upclocking. In the illustrated example, the bandwidth of the beam establishment training PPDU is ¼ that of a data PPDU.). The PPDU 900 can be applied using the best available Tx AWV/beam obtained from a beam establishment procedure or prior beam tracking procedure. In another example (e.g., following a beam establishment procedure) if successful data PPDU transmissions have occurred using a larger BW and the best available Tx/Rx AWV pair, the BW of the non-TRN field(s) 904 may be greater than that used for beam establishment or the same as that of the data PPDU.

In the illustrated example, the TRN field(s) 904-1, 904-2, 904-3 and 904-4 are appended at the end of the training PPDU to increase the training efficiency, and may be applied using different beams than a beam used for the non-TRN fields 902 (e.g., the PHY preamble and, if present, a data field). In this example, the TRN fields 904 can have the same bandwidth as the bandwidth of a data PPDU to improve measurement accuracy. The TRN field bandwidth information can be defined in the PHY preamble as one of the TRN field related parameters. In another example, different power scaling may be applied to the non-TRN field 902 and TRN fields 904 such that the same transmit power is realized across the entire packet.

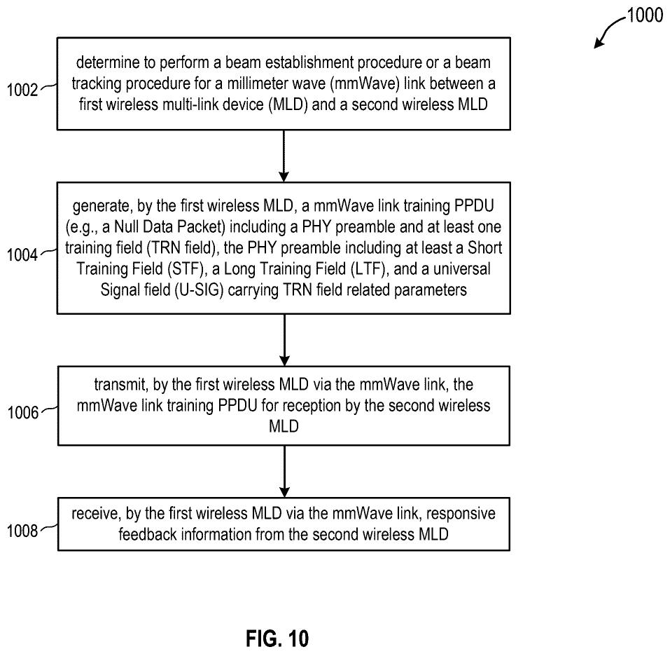

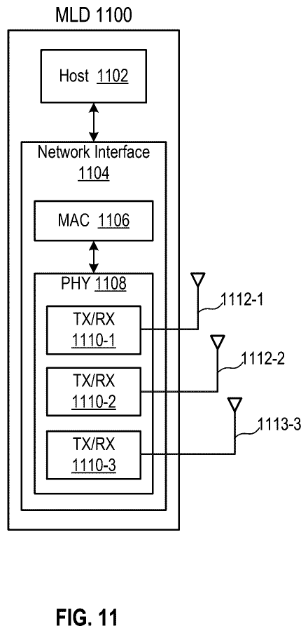

FIG. 10 is a flow chart illustrating an example method 1000 for performing a mm Wave link beamforming training procedure (e.g., a beam establishment or beam tracking procedure) in accordance with embodiments of the present disclosure. The process 700 can be performed by a AP MLD or non-AP MLD, such as the AP MLD 200 or the non-AP MLD 204 described with reference to FIG. 2 or the MLD 1100 described with reference to FIG. 11. The method 1000 may be utilized, for example, to establish, refine or recover a mm Wave link with an non-AP MLD.

The illustrated method begins at step 1002 where a first MLD (e.g., an AP MLD) determines to perform a beam establishment procedure or a beam tracking procedure for a millimeter wave (mmWave) link with a second MLD (e.g., a non-AP MLD). The method continues at step 1004, where the first MLD generates a mmWave link training PPDU (“training PPDU”). The training PPDU may have a format such as a format described with reference to FIG. 5, FIG. 7 or FIG. 8. In an example, the training PPDU is a Null Data Packet (NDP) and includes a PHY preamble and at least one training field (“TRN field”). In the illustrated example, the PHY preamble includes at least a Short Training Field (STF), a Long Training Field (LTF), and a universal Signal field (U-SIG) carrying TRN field related parameters. In an example, the bandwidth and format of the PHY preamble of the training PPDU for a beam establishment procedure or a beam tracking procedure are the same. In another example, one or more portions of the PHY preamble generally correspond to the (upclocked) PHY preamble of a sub-7 GHz orthogonal frequency-division multiplexing (OFDM) PPDU as defined by the IEEE 802.11 standard.

The method continues at step 1006, where the first MLD transmits, via the mm Wave link, the mm Wave link training PPDU for reception by the second wireless MLD. The first wireless MLD may then receive (at step 1008) responsive feedback information from the second MLD over the mm Wave link.

FIG. 11 illustrates an example of a wireless multi-link device (MLD) 1100 according to an embodiment of the present disclosure. The MLD 1100 is configurable (e.g., as an AP MLD or non-AP MLD) to perform a mmWave link beamforming training procedures according to any of the various embodiments described herein. The illustrated MLD 1100 includes a host processor 1102 coupled to a network interface device 1104. The network interface device 1104 includes a medium access control (MAC) processing unit 1106 and a physical layer (PHY) processing unit 1108. The PHY processing unit 1108 includes a plurality of transceivers 1110 coupled to a plurality of antennas 1112. Although three transceivers 1110 (1110-1, 1110-2 and 1110-3) and three antennas 1112 (1112-1, 1112-2 and 1112-3) are illustrated in FIG. 1, the MLD 1100 includes other suitable numbers (e.g., 1, 2, 4, 5, etc.) of transceivers 1110 and antennas 1112 in other embodiments. In an example, the MAC processing unit 1106 and the PHY processing unit 1108 are configured to operate in compliance with the IEEE 802.11bn and 802.11bq amendments to the IEEE 802.11 standard. In an example, the network interface device 1104 includes one or more integrated circuit (IC) devices. In this example, at least some of the functionality of the MAC processing unit 1106 and at least some of the functionality of the PHY processing unit 1108 can be implemented on a single IC device. As another example, at least some of the functionality of the MAC processing unit 1106 is implemented on a first IC device, and at least some of the functionality of the PHY processing unit 1108 is implemented on a second IC device. The MLD 1100 may communicate with a plurality of (MLD) client stations and/or APs (not separately illustrated), including both legacy and non-legacy client stations.

In various embodiments, the PHY processing unit 1108 of the MLD 1100 is configured to generate data units conforming to a non-legacy communication protocol and having formats described herein. The transceiver(s) 1110 is/are configured to transmit the generated data units via the antenna(s) 1112. Similarly, the transceiver(s) 1110 is/are configured to receive data units via the antenna(s) 1112. The PHY processing unit 1108 of the MLD 1100 is configured to process received data units conforming to the non-legacy communication protocol and having formats described herein and to determine that such data units conform to the non-legacy communication protocol.

In an embodiment, when operating in single-user mode, the MLD 1100 transmits a data unit to a single client station (DL SU transmission), or receives a data unit transmitted by a single client station (UL SU transmission), without simultaneous transmission to, or by, any other client station. When operating in multi-user mode, the MLD 1100 transmits a data unit that includes multiple data streams for multiple client stations (DL MU transmission), or receives data units simultaneously transmitted by multiple client stations (UL MU transmission). For example, in multi-user mode, a data unit transmitted by the MLD includes multiple data streams simultaneously transmitted by the MLD 1100 to respective client stations using respective spatial streams allocated for simultaneous transmission to the respective client stations and/or using respective sets of OFDM tones corresponding to respective frequency subbands allocated for simultaneous transmission to the respective client stations. In a further example, the MLD 1100 may be configured as a multi-link device, such as the AP MLD 102 or STA MLD 104-1 described above with reference to FIG. 1 or the AP MLD 200 or non-AP MLD 204 described above with reference to FIG. 2.

In an example, the MLD 1100 is configured to generate control or management information regarding a millimeter wave (mmWave) link between the MLD 1100 and a second MLD, and the transceivers 1110 is/are configured to transmit the control or management information (e.g., mmWave beam establishment announcement information regarding a mmWave link to initiate a beamforming training procedure, training PPDU related information, etc.) to the second MLD through the mm Wave link or through a non-mm Wave link between the MLD 1100 and the second MLD. In some embodiments, the non-mm Wave link includes one of a 2.4 Gigahertz (GHz) link, a 5 GHz link, or a 6 GHz link, and the mm Wave link includes a 45 GHz link or a 60 GHz link.

While the innovate aspects of the present disclosure have been generally described in the context of the 802.11bq amendment, and future generations, of the IEEE 802.11 standard, a person having ordinary skill in the art will readily recognize that teachings herein may be applied to other wireless networks and standards including, for example, cellular network standards and Bluetooth standards.

The innovative methods and apparatus illustrated in the drawings and described herein provide for mmWave link beamforming training PPDU design and related procedures. In an illustrative, non-limiting embodiment, a method for beamforming training of a millimeter wave link (mm Wave link) by a wireless multi-link device (MLD) is provided. The method includes determining to perform a beam establishment procedure or a beam tracking procedure for the mmWave link. The method further includes generating a mm Wave link training PPDU (training PPDU), wherein the training PPDU is a Null Data Packet (NDP) and includes a PHY preamble. In this method, the PHY preamble includes a Short Training Field (STF), a Long Training Field (LTF), and a universal Signal field (U-SIG field) carrying beam training parameters. The method further includes transmitting the training PPDU, via the mm Wave link, for reception by a second wireless MLD.

The method of this embodiment includes optional aspects. With one optional aspect, the PHY preamble corresponds to an upclocked PHY preamble of a sub-7 GHz orthogonal frequency-division multiplexing (OFDM) PPDU as defined by the IEEE 802.11 standard. In another optional aspect, the LTF corresponds to an upclocked LTF of a sub-7 GHz orthogonal frequency-division multiplexing (OFDM) PPDU as defined by the IEEE 802.11 standard, and wherein the LTF includes a legacy or non-legacy LTF sequence design. With another optional aspect, the training PPDU further includes at least one training field (TRN field), and the PHY preamble further includes a Signal field (SIG field) carrying TRN field related parameters. In another optional aspect, transmitting the training PPDU includes transmitting the PHY preamble with a first beam and transmitting at least one TRN field with a differing beam. In a further optional aspect, the at least one TRN field has the same bandwidth as an operating bandwidth for transmitting a data PPDU via the mm Wave link, and wherein a different power scaling is applied to the PHY preamble and the at least one TRN field. In yet another optional aspect, the training PPDU is configured to train a plurality of radio frequency (RF) chains and includes a plurality of TRN fields, and wherein each TRN field includes a number of LTF symbols that is correlated to the number of RF chains.

In another optional aspect, the training PPDU is generated in response to determining to perform a beam establishment procedure. In this optional aspect, the method further includes determining to perform a beam tracking procedure for the mmWave link and generating a second training PPDU. The second training PPDU is a data frame and includes a PHY preamble, a data field and at least one training field (TRN field). In this optional aspect, the PHY preamble includes a STF, a LTF, and a U-SIG field, wherein the U-SIG field, and an Integrated Millimeter Wave SIG field (IMMW-SIG field), wherein the IMMW-SIG field and the data field carry TRN field related parameters. The method of this optional aspect further includes transmitting the second training PPDU, via the mmWave link, for reception by the second wireless MLD. In a further optional aspect, the at least one TRN field is configured in accordance with the TRN field related parameters for a transmit beam training type, a receive beam training type, or a transmit/receive beam training type, and wherein the TRN field related parameters indicate an antenna weight vector (AWV) correspondence. In another optional aspect, the bandwidth and format of a packet detection portion of the PHY preamble of the training PPDU for a beam establishment procedure or a beam tracking procedure are the same.

In another optional aspect, the training PPDU is configured for the beam establishment procedure and has a smaller bandwidth than an operating bandwidth for transmitting a data PPDU via the mmWave link. In a further optional aspect, the beam training parameters include one or more of a sector identifier, a beam index, a transmit radio frequency (RF) chain identifier, a training PPDU index, or a countdown index.

With another illustrative, non-limiting embodiment, a wireless multi-link device (MLD) includes a plurality of wireless transceivers and one or more processing modules operably coupled to the plurality of wireless transceivers. The one or more processing modules are arranged to determine to perform a beam establishment procedure or a beam tracking procedure for the mm Wave link. The one or more processing modules are further arranged to generate a mm Wave link training PPDU (training PPDU), wherein the training PPDU is a Null Data Packet (NDP) and includes a PHY. In this embodiment, the PHY preamble includes a Short Training Field (STF), a Long Training Field (LTF), and a universal Signal field (U-SIG field) carrying beam training parameters. The one or more processing modules are further arranged to transmit the training PPDU, via the mmWave link, for reception by a second wireless MLD.

This embodiment includes optional aspects. With one optional aspect, the PHY preamble corresponds to an upclocked PHY preamble of a sub-7 GHz orthogonal frequency-division multiplexing (OFDM) PPDU as defined by the IEEE 802.11 standard. In another optional aspect, the LTF corresponds to an upclocked LTF of a sub-7 GHz orthogonal frequency-division multiplexing (OFDM) PPDU as defined by the IEEE 802.11 standard.

In another optional aspect, the training PPDU further includes at least one training field (TRN field), and wherein the PHY preamble further includes a Signal field (SIG field) carrying additional TRN field related parameters. In another optional aspect, transmitting the training PPDU includes transmitting the PHY preamble with a first beam and transmitting at least one TRN field with a differing beam.

In another optional aspect, the training PPDU is generated in response to determining to perform a beam establishment procedure. In this optional aspect, the one or more processing modules are further arranged to determine to perform a beam tracking procedure for the mm Wave link and generate a second training PPDU. The second training PPDU is a data frame and includes a PHY preamble, a data field and at least one training field (TRN field). In this optional aspect, the PHY preamble includes a STF, a LTF, a U-SIG field, and an Integrated Millimeter Wave SIG field (IMMW-SIG field, wherein the IMMG-SIG field and the data field carry TRN field related parameters. In this optional aspect, the one or more processing modules are further arranged to transmit the second training PPDU, via the mm Wave link, for reception by the second wireless MLD.

In a further optional aspect, the at least one TRN field is configured in accordance with the TRN field related parameters for a transmit beam training type, a receive beam training type, or a transmit/receive beam training, and the TRN field related parameters indicate an antenna weight vector (AWV) correspondence. In another optional aspect, transmitting the training PPDU includes transmitting the PHY preamble with a first beam and transmitting at least one TRN field with a differing beam.

With another illustrative, non-limiting embodiment, a method for beamforming training of a millimeter wave link (mmWave link) by a wireless multi-link device (MLD) is provided. The method includes determining to perform a beam tracking procedure for the mm Wave link. The method further includes generating a mmWave link training PPDU (training PPDU), wherein the training PPDU includes a PHY preamble and at least one training field (TRN field). The PHY preamble includes a Short Training Field (STF), a Long Training Field (LTF), a universal Signal field (U-SIG field), and a Signal field (SIG field). In this method, the format of the training PPDU corresponds to an upclocked sub-7 GHz orthogonal frequency-division multiplexing (OFDM) PPDU as defined by the IEEE 802.11 standard, and one or more subfields of the U-SIG field or SIG field are redefined to carry TRN field related parameters. The method further includes transmitting the training PPDU, via the mmWave link, for reception by a second wireless MLD.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for beamforming training of a millimeter wave link (mmWave link) by a wireless multi-link device (MLD), comprising:
determining to perform a beam establishment procedure or a beam tracking procedure for the mmWave link;
generating a mmWave link training PPDU (training PPDU), wherein the training PPDU is a Null Data Packet (NDP) and includes a PHY preamble, and wherein the PHY preamble includes:
a Short Training Field (STF);
a Long Training Field (LTF); and
a universal Signal field (U-SIG field) carrying beam training parameters; and
transmitting the training PPDU, via the mmWave link, for reception by a second wireless MLD.

2. The method of claim 1, wherein the PHY preamble corresponds to an upclocked PHY preamble of a sub-7 GHz orthogonal frequency-division multiplexing (OFDM) PPDU as defined by the IEEE 802.11 standard.

3. The method of claim 1, wherein the LTF corresponds to an upclocked LTF of a sub-7 GHz orthogonal frequency-division multiplexing (OFDM) PPDU as defined by the IEEE 802.11 standard, and wherein the LTF includes a legacy or non-legacy LTF sequence design.

4. The method of claim 1, wherein the training PPDU further includes at least one training field (TRN field), and wherein the PHY preamble further includes a Signal field (SIG field) carrying TRN field related parameters.

5. The method of claim 4, wherein transmitting the training PPDU includes transmitting the PHY preamble with a first beam and transmitting at least one TRN field with a differing beam.

6. The method of claim 4, the at least one TRN field has the same bandwidth as an operating bandwidth for transmitting a data PPDU via the mmWave link, and wherein a different power scaling is applied to the PHY preamble and the at least one TRN field.

7. The method of claim 4, wherein the training PPDU is configured to train a plurality of radio frequency (RF) chains and includes a plurality of TRN fields, and wherein each TRN field includes a number of LTF symbols that is correlated to the number of RF chains.

8. The method of claim 1, wherein the training PPDU is generated in response to determining to perform a beam establishment procedure, further comprising:
determining to perform a beam tracking procedure for the mmWave link;
generating a second training PPDU, wherein the second training PPDU is a data frame and includes a PHY preamble, a data field and at least one training field (TRN field), and wherein the PHY preamble of the second training PPDU includes:
a STF;
a LTF; and
a U-SIG field; and
an Integrated Millimeter Wave SIG field (IMMW-SIG field), wherein the IMMW-SIG field and the data field carry TRN field related parameters; and
transmitting the second training PPDU, via the mmWave link, for reception by the second wireless MLD.

9. The method of claim 8, wherein the at least one TRN field is configured in accordance with the TRN field related parameters for a transmit beam training type, a receive beam training type, or a transmit/receive beam training type, and wherein the TRN field related parameters indicate an antenna weight vector (AWV) correspondence.

10. The method of claim 8, wherein the bandwidth and format of a packet detection portion of the PHY preamble of the training PPDU for a beam establishment procedure or a beam tracking procedure are the same.

11. The method of claim 1, wherein the training PPDU is configured for the beam establishment procedure and has a smaller bandwidth than an operating bandwidth for transmitting a data PPDU via the mmWave link.

12. The method of claim 1, wherein the beam training parameters include one or more of a sector identifier, a beam index, a transmit radio frequency (RF) chain identifier, a training PPDU index, or a countdown index.

13. A wireless multi-link device (MLD), comprising:
one or more wireless transceivers; and
one or more processors operably coupled to the one or more wireless transceivers, wherein the one or more processors are arranged to:
determine to perform a beam establishment procedure or a beam tracking procedure for the mmWave link;
generate a mmWave link training PPDU (training PPDU), wherein the training PPDU is a Null Data Packet (NDP) and includes a PHY and wherein the PHY preamble includes:
a Short Training Field (STF);
a Long Training Field (LTF); and
a universal Signal field (U-SIG field) carrying beam training related parameters; and
transmit the training PPDU, via the mmWave link, for reception by a second wireless MLD.

14. The wireless MLD of claim 13, wherein the PHY preamble corresponds to an upclocked PHY preamble of a sub-7 GHz orthogonal frequency-division multiplexing (OFDM) PPDU as defined by the IEEE 802.11 standard.

15. The wireless MLD of claim 13, wherein the LTF corresponds to an upclocked LTF of a sub-7 GHz orthogonal frequency-division multiplexing (OFDM) PPDU as defined by the IEEE 802.11 standard.

16. The wireless MLD of claim 13, wherein the training PPDU further includes at least one training field (TRN field), and wherein the PHY preamble further includes a Signal field (SIG field) carrying additional TRN field related parameters.

17. The wireless MLD of claim 16, wherein transmitting the training PPDU includes transmitting the PHY preamble with a first beam and transmitting at least one TRN field with a differing beam.

18. The wireless MLD of claim 13, wherein the training PPDU is generated in response to determining to perform a beam establishment procedure, and wherein the one or more processors are further arranged to:
determine to perform a beam tracking procedure for the mmWave link;
generate a second training PPDU, wherein the second training PPDU is data frame and includes a PHY preamble, a data field and at least one training field (TRN field), and wherein the PHY preamble of the second training PPDU includes:
a STF;
a LTF; and
a U-SIG field; and
an Integrated Millimeter Wave SIG field (IMMW-SIG field), wherein the IMMG-SIG field and the data field carry TRN field related parameters; and
transmit the second training PPDU, via the mmWave link, for reception by the second wireless MLD.

19. The wireless MLD of claim 13, wherein the at least one TRN field is configured in accordance with the TRN field related parameters for a transmit beam training type, a receive beam training type, or a transmit/receive beam training type, and wherein the TRN field related parameters indicate an antenna weight vector (AWV) correspondence.

20. A method for beamforming training of a millimeter wave link (mmWave link) by a wireless multi-link device (MLD), comprising:
determining to perform a beam tracking procedure for the mmWave link;
generating a mm Wave link training PPDU (training PPDU), wherein the training PPDU includes a PHY preamble and at least one training field (TRN field), and wherein the PHY preamble includes:
a Short Training Field (STF);
a Long Training Field (LTF);
a universal Signal field (U-SIG field); and
a Signal field (SIG field), wherein with the exception of the at least one training field, the format of the training PPDU corresponds to an upclocked sub-7 GHz orthogonal frequency-division multiplexing (OFDM) PPDU as defined by the IEEE 802.11 standard, and wherein one or more subfields of the U-SIG field or SIG field are redefined to carry TRN field related parameters; and
transmitting the training PPDU, via the mmWave link, for reception by a second wireless MLD.
